(19) United States
(12) Patent Application Publication
(10) Pub. No.: US 2008/0067159 A1
(43) Pub. Date: Mar. 20, 2008

(54) LASER PROCESSING SYSTEM AND METHOD FOR MATERIAL PROCESSING

(75) Inventors: Wenwu Zhang, Schenectady, NY (US); Magdi Naim Azer, Niskayuna, NY (US); Marshall Gordon Jones, Scotia, NY (US); Leon Eric LaGalles, Ballston Spa, NY (US); Clarence Albert Ash, Burlington, KY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/532,947

(22) Filed: Sep. 19, 2006

(51) Int. Cl. B23K 26/14

(52) U.S. Cl. 219/121.84

(57) ABSTRACT

A laser processing system includes a laser source configured to transmit a laser beam. A hollow focusing device is configured to focus the laser beam to a work piece. A pressure source is coupled to the hollow focusing device and configured to feed a pressurized liquid through the hollow focusing device. A liquid container is configured to receive a portion of the pressurized liquid from the hollow focusing device. The laser beam is transmitted through the pressurized liquid in the hollow focusing device to the work piece disposed in the portion of the pressurized liquid in the liquid container.

### BACKGROUND

The invention relates generally to material processing systems and, more particularly, a laser processing system for material processing, for example, laser drilling.

During material processing, such as machining, thermal treatment, and laser shock peening, for example, high intensity energy sources, such as photon energy sources, are often used. Higher laser intensity (e.g. 10⁸ W/cm²) may be used to achieve higher laser machining quality. When higher laser intensity is used, processing material vaporizes in shorter period of time, and the fraction of material ablated may be increased. Lasers having smaller pulse energy and shorter pulse duration may be used for machining shallow features, but may not be economical for drilling deeper holes or for cutting thicker section material.

In one example, laser percussion drilling is employed to drill large quantities of cooling holes through high temperature alloy material during aircraft engine manufacturing. Lasers used for drilling purposes may have a large pulse energy (e.g. 1-30 joules) and a relatively long pulse duration (e.g. greater than 100 microsecond). Conventional laser drilling results in faster material removal, but it also results in considerable melting and re-attachment around machined features of the processing material. Also, the heat affected zone in the processing material is greater which may lead to initiation of micro-cracks.

Accordingly, there is a need for a system for transmitting sufficiently high laser energy to a work piece, while reducing heat affected zone and flushing away machined material.

### BRIEF DESCRIPTION

In accordance with one exemplary embodiment of the present invention, a laser processing system includes a laser source configured to transmit a laser beam. A hollow focusing device is configured to focus the laser beam to a work piece. A pressure source is coupled to the hollow focusing device and configured to feed a pressurized liquid through the hollow focusing device. A liquid container is configured to receive a portion of the pressurized liquid from the hollow focusing device. The laser beam is transmitted through the pressurized liquid in the hollow focusing device to the work piece disposed in the portion of the pressurized liquid in the liquid container.

In accordance with another exemplary embodiment of the present invention, a laser processing method includes feeding a pressurized liquid through a hollow focusing device via a pressure source. The method includes selectively feeding a portion of the pressurized liquid from the hollow focusing device to a liquid container. The method further includes transmitting a laser beam from a laser source to a work piece disposed in the portion of the pressurized liquid in the liquid container through the pressurized liquid in the hollow focusing device.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical view of a laser processing system provided to machine a work piece in accordance with an exemplary embodiment of the present invention;

FIG. 2 is a diagrammatical view illustrating bubble expulsion during laser machining of a work piece in accordance with the aspects of FIG. 1; and

FIG. 3 is a diagrammatical view of a laser processing system provided to machine a work piece in accordance with another exemplary embodiment of the present invention.

### DETAILED DESCRIPTION

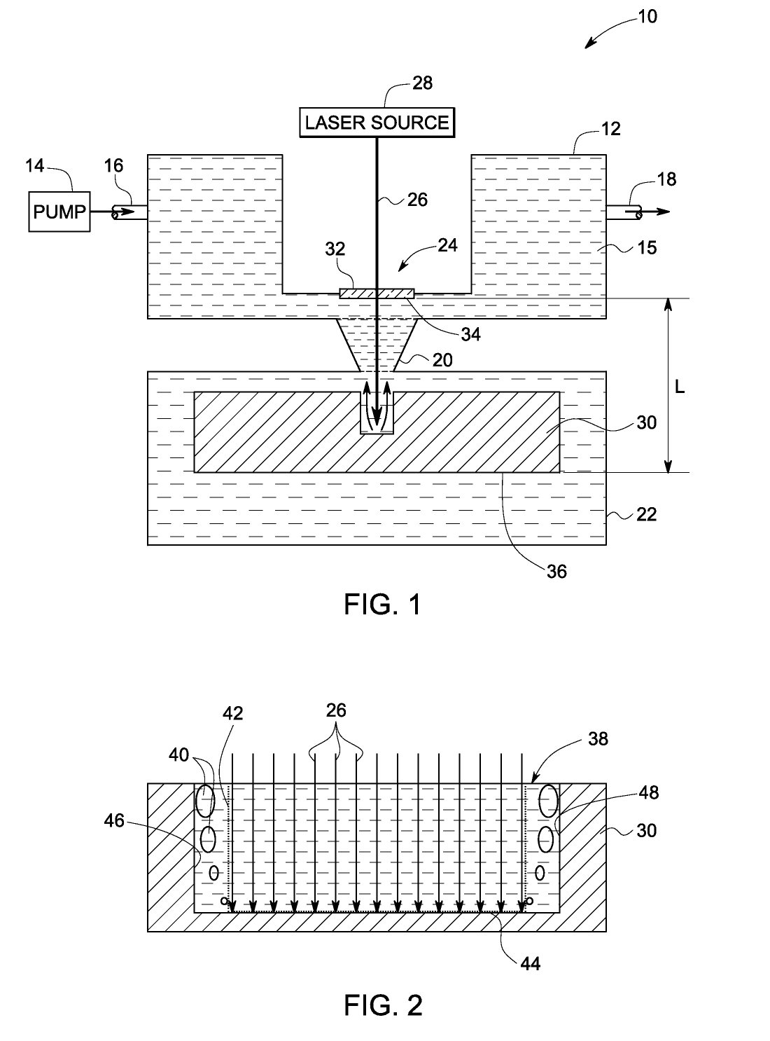

As discussed in detail below, embodiments of the present invention provide a laser processing system in which a hollow focusing device is configured to focus a laser beam onto a work piece. A pressure source feeds a pressurized liquid through the hollow focusing device. A liquid container is configured to receive a portion of the pressurized liquid from the hollow focusing device. The laser beam is transmitted through the pressurized liquid in the hollow focusing device to the work piece disposed in the portion of the pressurized liquid in the liquid container. The laser processing system in accordance with the embodiments of the present invention transmits “sufficiently high laser energy” to the work piece through the pressurized liquid. It should be noted that “sufficiently high laser energy” is the energy required to cause ablation of material from the surface of the work piece. In certain exemplary embodiments, the laser energy required to cause ablation of material from the surface of the work piece may be in the range of 0.01 to several Giga watts per centimeter squared (GW/cm2). The pressurized liquid flow facilitates to reduce heat-affected zone of the work piece, thereby preventing initiation of micro cracks. The pressurized liquid flow also facilitates flushing away the machined material from the work piece. Specific embodiments of the present invention are discussed below referring generally to FIGS. 1-3.

Referring to FIG. 1, a laser processing system 10 is illustrated in accordance with an exemplary embodiment of the present invention. The system 10 includes a hollow focusing device 12 (i.e. hollow container) and a pressure source 14, such as a pump coupled to an inlet 16 of the hollow focusing device 12. The pressure source 14 is configured to feed a pressurized liquid 15 such as water through the hollow focusing device 12 via the inlet 16. The focusing device 12 also includes an outlet 18 configured to eject the pressurized liquid 15 from the focusing device 12. A valve mechanism may be provided to the outlet 18 to control the flow of pressurized liquid through the outlet 18. The focusing device 12 further includes a nozzle 20 configured to selectively discharge a portion of the pressurized liquid from the focusing device 12 to a liquid container 22. The nozzle 20 may also be provided with a control valve to control the flow of pressurized liquid via the nozzle 20 to the liquid container 22. Although a U-shaped focusing device is illustrated, other suitable shaped focusing devices suitable for laser processing techniques are envisaged.

The illustrated focusing device 12 includes a transparent portion 24 configured to transmit a laser beam 26 from a laser source 28 to a work piece 30 disposed in the portion of the pressurized liquid filling the liquid container 22. In the illustrated embodiment, the transparent portion 24 includes a focusing lens 32 provided to focus the laser beam 26 via the nozzle 20 to the work piece 30. The lens 32 and the work piece 30 are disposed in such a way so as to maintain a predetermined distance “L” between one side (rear side) 34 of the lens 32 and a first side 36 of the work piece 30. Decay of laser energy increases with increase in the distance “L”. The distance “L” is chosen in such as way so as to transmit sufficiently high laser energy to the work piece 30. As mentioned earlier, “sufficiently high laser energy” is the energy required to cause ablation of material from the surface of the work piece 30. The propagation of laser energy to the work piece occurs entirely through the liquid medium. Liquid flow velocity inside machined features of the work piece 30 increases with decrease in the distance “L”. The liquid flow is generated due to the flow of pressurized liquid from the inlet 16 to the outlet 18 and also due to shock wave generated in the portion of pressurized liquid in the liquid container 22 when the laser beam 26 strikes the surface of the work piece 30. The liquid flow within the hollow focusing device 12 and the liquid container 22 facilitates flushing away machined material from the work piece 30 and also reduces heat-affected zones in the work piece 30.

Distance “L” is determined based on the amount of laser absorption in the liquid medium. In certain embodiments, L is less than 20 mm and laser beams having a wavelength of 450 nanometers, 532 nanometers, and 355 nanometers retain more than 95% of their initial laser energy when the beam strikes the work piece via the liquid medium. In certain other embodiments, L is equal to 10 mm and laser beams having a wavelength of 1060 nanometers retain more than 87% of their initial laser energy when the beam strikes the work piece via the liquid medium. In certain embodiments, the liquid medium may include water, or chemical solutions such as acid.

A laser processing system 10 in accordance with certain exemplary embodiments of the invention may be used for various applications such as, but not limited to, laser drilling, laser cutting, microscale laser machining, laser cleaning, laser marking, laser direct writing, laser material treatment, laser shock peening, or the like. In certain embodiments, the exemplary laser processing system 10 may be used to drill cooling holes for aircraft engines. In certain other exemplary embodiments, the laser processing system 10 may use a micro-lens as the transparent portion and may be used for high spatial resolution laser machining, such as micro and nano laser machining. In certain other exemplary embodiments, the laser processing system 10 may use chemical solutions such as acid for chemical etching and laser machining the work piece disposed in the liquid container.

Referring to FIG. 2, bubble expulsion during liquid flow assisted laser machining in accordance with the aspects of FIG. 1 is illustrated. As discussed previously, the focusing device includes the transparent portion configured to transmit the laser beam 26 from the laser source to the work piece 30 disposed in the portion of the pressurized liquid in the liquid container. In the illustrated embodiment, a plurality of laser beams 26 is transmitted to the work piece to drill a machined feature (i.e. cavity) 38 in the work piece 30. Although in the illustrated embodiment, a plurality of laser beams are illustrated, in certain other exemplary embodiments, a single laser beam may be focused to a single location on the surface of the work piece to drill a machined feature in the work piece 30. During the laser machining process in the work piece, when the laser beams 26 strikes the surface of the work piece 30, bubbles 40 are generated in the portion of liquid filling the cavity 38 as material is heated and removed. The liquid flow pattern in the cavity 38 ensures that a central portion of the liquid (represented by dotted rectangular region) 42 flows to a bottom portion 44 of the cavity 38. The bubbles 40 generated during machining process are flushed to both peripheral sides 46, 48 of the cavity 38. Thereby, “a constant transparent liquid channel” is maintained in a center portion of the cavity 38 because the bubbles are flushed away to the peripheral sides 46, 48 of the cavity 38. The constant transparent liquid channel facilitates to reduce decay of transmitted laser energy. Random reflection and diffraction of incident laser energy is therefore prevented. The point of impingement of the laser radiation is simultaneously cooled and rinsed by the liquid. Vapors and odors generated from the work piece may also be absorbed by the liquid medium. The liquid flow in the cavity 38 also facilitates to flush away the machined material from the work piece.

In accordance with certain exemplary embodiments of the present invention, lower power laser beams having a wavelength in the visible and ultraviolet range, or higher power lasers may be used. In one example, industrial high power lasers having a wavelength of 1070 nanometers, or 1060 nanometers, or 810 nanometers, or 532 nanometers, or 355 nanometers, or combination thereof may be used. The industrial high power lasers may include direct diode lasers, fiber lasers, Nd:YAG lasers, and carbon dioxide lasers, 532 nanometer green lasers, 355 nanometer ultraviolet lasers, or the like.

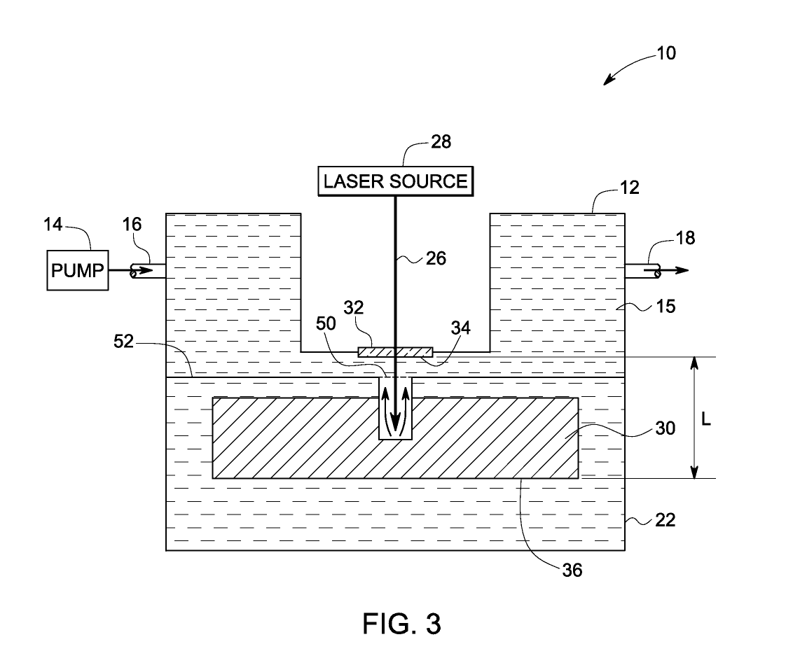

Referring now to FIG. 3, the laser processing system 10 is illustrated in accordance with another exemplary embodiment of the present invention. The system 10 includes the hollow focusing device 12 and the pressure source 14 coupled to an inlet 16 of the hollow focusing device 12. The pressure source 14 is configured to feed the pressurized liquid 15 through the hollow focusing device 12 via the inlet 16. The focusing device 12 also includes the outlet 18 configured to eject the pressurized liquid 15 from the focusing device 12. In the illustrated embodiment, the focusing device 12 further includes a hole 50 (instead of nozzle 20 provided in the previous embodiment) provided in a bottom wall 52 of the device 12 configured to selectively discharge a portion of the pressurized liquid from the focusing device 12 to the liquid container 22. The hole 50 may also be provided with a control valve to control the flow of pressurized liquid via the hole 20 to the liquid container 22.

In the illustrated embodiment, the device 12 includes the focusing lens 32 provided to focus the laser beam 26 via the nozzle 20 to the work piece 30. In alternate exemplary embodiments, the device 12 may include a delivery fiber or a combination of focusing lens and the delivery fiber to focus the laser beam to the work piece. It should be noted that the delivery fiber may include a solid core fiber and may be located protruding closer towards the work piece to focus the laser beam to the work piece. In certain other exemplary embodiments, the device 12 includes a micro lens to focus the laser beam to the work piece. The lens 32 and the work piece 30 are disposed in such a way so as to maintain a predetermined distance “L” between one side (rear side) 34 of the lens 32 and the first side 36 of the work piece 30. The distance “L” is chosen in such as way so as to transmit sufficiently high laser energy to the work piece 30. The distance “L” is minimized to limit the amount of laser power decay due to transmission of laser beam through the liquid medium. The provision of hole 50 further facilitates reducing the distance “L”. The liquid flow within the hollow focusing device 12 and the liquid container 22 facilitates flushing away machined material from the work piece 30 and also reduces heat-affected zones in the work piece 30.

When a hole is drilled using conventional laser processing techniques (for example, transmitting laser beams through air to the work piece), removed material tends to build up at the edge of the machined region and may fuse to the non-machined region, forming a ring on the work piece. In accordance with exemplary embodiments of the present invention, the pressurized liquid flow facilitates flushing away the machined material from the work piece and preventing it from fusing to the edge of the machined region. Thereby the liquid medium facilitates to reduce the extrusion of removed material from the work piece. The extrusion of removed material is mitigated due to enhanced strength of the liquid medium.

In another exemplary embodiment, the laser processing system 10 may be used to drill holes at an angle to a surface of a work piece 30. A short decay nozzle system (not shown) may be used to focus the laser beam 26 to the surface of the work piece 30. The short decay nozzle system is configured to feed a pressurized liquid against the work piece 30. The laser beam is transmitted through the pressurized liquid to the work piece disposed in the portion of the pressurized liquid in the liquid container. When the short decay nozzle system is tilted relative to the work piece 30, tilted holes may be drilled in the work piece. In certain exemplary embodiments, the nozzle system may be tilted and the laser beam may be focused to the surface of the work piece. In certain other exemplary embodiments the nozzle system may be tilted and the laser beam may be focused to a portion below the surface of the work piece. It should be noted here that focusing the laser beam to a portion below the surface of the work piece is an exemplary technique and that other techniques may be adopted depending on the requirement. The laser processing system in accordance with the embodiments of the present invention transmits sufficiently high laser energy to the work piece through the pressurized liquid. As discussed in previous embodiments, “sufficiently high laser energy” is the energy required to cause ablation of material from the surface of the work piece 30. The laser beam may be transmitted to the work piece without significant energy losses through the liquid medium. The pressurized liquid flow facilitates reducing the heat-affected zone of the work piece, thereby preventing initiation of micro cracks. The pressurized liquid flow also facilitates flushing away the machined material from the work piece.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A laser processing system, comprising:
a laser source configured to transmit a laser beam;
a hollow focusing device configured to focus the laser beam to a work piece;
a pressure source coupled to the hollow focusing device and configured to feed a pressurized liquid through the hollow focusing device; and
a liquid container configured to receive a portion of the pressurized liquid from the hollow focusing device;
wherein the laser beam is transmitted through the pressurized liquid in the hollow focusing device to the work piece disposed in the portion of the pressurized liquid in the liquid container.

2. The system of claim 1, wherein the laser beam has a wavelength greater than 355 nanometers.

3. The system of claim 1, wherein the hollow focusing device comprises a hollow container and wherein the pressure source is coupled to the hollow container and configured to feed the pressurized liquid through the hollow container.

4. The system of claim 3, wherein the hollow container comprises an inlet coupled to the pressure source and configured to intake pressurized liquid into the hollow container.

5. The system of claim 4, wherein the hollow container comprises an outlet and is configured to eject the pressurized liquid from the hollow container.

6. The system of claim 5, wherein the hollow container comprises a transparent portion configured to transmit the laser beam to the work piece disposed in the portion of the pressurized liquid in the liquid container.

7. The system of claim 6, wherein the transparent portion comprises a focusing lens configured to transmit the laser beam to the work piece disposed in the portion of the pressurized liquid in the liquid container.

8. The system of claim 6, wherein a distance between one side of the transparent portion and a first side of the work piece is configured depending on the laser absorption in the pressurized liquid.

9. The system of claim 8, wherein the hollow container comprises a nozzle configured to selectively discharge the portion of pressurized liquid from the hollow container to the liquid container.

10. The system of claim 9, wherein the nozzle is configured to focus the laser beam through the pressurized liquid in the hollow container to the work piece disposed in the portion of the pressurized liquid in the liquid container.

11. The system of claim 8, wherein the hollow container comprises a hole configured to selectively discharge the portion of pressurized liquid from the hollow container to the liquid container.

12. The system of claim 11, wherein the hole is configured to focus the laser beam through the pressurized liquid in the hollow container to the work piece disposed in the portion of the pressurized liquid in the liquid container.

13. The system of claim 1, wherein the pressurized liquid comprises water.

14. The system of claim 1, wherein the pressurized liquid comprises a chemical solution.

15. A laser processing method, comprising:
feeding a pressurized liquid through a hollow focusing device via a pressure source;
selectively feeding a portion of the pressurized liquid from the hollow focusing device to a liquid container; and
transmitting a laser beam from a laser source to a work piece disposed in the portion of the pressurized liquid in the liquid container via the pressurized liquid in the hollow focusing device.

16. The method of claim 15 wherein the laser beam has a wavelength of 355 nm.

17. The method of claim 15, wherein feeding the pressurized liquid through the hollow focusing device comprises feeding the pressurized liquid through a hollow container.

18. The method of claim 17, comprising transmitting the laser beam via a transparent portion provided in the hollow container to the work piece disposed in the portion of the pressurized liquid in the liquid container.

19. The method of claim 17, comprising transmitting the laser beam via a focusing lens provided in the hollow container to the work piece disposed in the portion of the pressurized liquid in the liquid container.

20. The method of claim 17, comprising selectively feeding the portion of pressurized liquid from the hollow container to the liquid container via a nozzle provided in the hollow container.

21. The method of claim 20, comprising focusing the laser beam through the pressurized liquid in the hollow container to the work piece disposed in the portion of the pressurized liquid in the liquid container via the nozzle provided in the hollow container.

22. The method of claim 17, comprising selectively feeding the portion of pressurized liquid from the hollow container to the liquid container via a hole provided in the hollow container.

23. The method of claim 22, comprising focusing the laser beam through the pressurized liquid in the hollow container to the work piece disposed in the portion of the pressurized liquid in the liquid container via the hole provided in the hollow container.
